(19) United States
(12) Patent Application Publication
(10) Pub. No.: US 2020/0098348 A1
(43) Pub. Date: Mar. 26, 2020

(54) Device, System, and Method for Controlling the Focus of a Laser to Induce Plasmas that Emit Acoustic Pressure Waves to Control Movement of an Object

(71) Applicant: SPAWAR Systems Center Pacific, San Diego, CA (US)

(72) Inventors: Bienvenido Melvin L. Pascoguin, La Mesa, CA (US); Ryan P. Lu, San Diego, CA (US); Ayax D. Ramirez, Chula Vista, CA (US)

(73) Assignee: United States of America as represented by Secretary of the Navy, San Diego, CA (US)

(21) Appl. No.: 16/136,600

(22) Filed: Sep. 20, 2018

(51) Int. Cl. G10K 15/02; G10K 11/34; G02B 5/18

(52) U.S. Cl. CPC G10K 15/02; G02B 26/02; G02B 5/1871; G10K 11/346

(57) ABSTRACT

A focus controlling component is configured to control a focus of a laser beam to have respective focal points surrounding an object. The laser beam induces respective plasmas at the respective focal points. The respective plasmas emit respective acoustic pressure waves that control movement of the object.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619) 553-5118; email: ssc pac t2@navy.mil, referencing NC 103888.

### FIELD OF THE INVENTION

The present disclosure pertains generally to laser-induced plasmas that emit acoustic pressure waves. More particularly, the present disclosure pertains to controlling a focus of a laser to induce plasmas that emit acoustic pressure waves to control movement of an object.

### BACKGROUND

Acoustic pressure waves have been shown to be useful to manipulate an object inside an enclosure. In a conventional approach, speakers have been used in an enclosure to generate acoustic pressure waves to cause levitation of an object in the enclosure.

A drawback of this approach is that it is confined within a fixed enclosure. This limits the physical spatial movement of objects. Also, this approach requires large speakers that are capable of generating acoustic pressure waves with enough intensity to cause levitation of an object.

In view of the above, it would be desirable to control the movement of an object using acoustic pressure waves in an unenclosed space without using large speakers to generate the acoustic pressure waves.

### SUMMARY

According to an illustrative embodiment, a focus controlling component is configured to control a focus of a laser beam to have respective focal points surrounding an object. The laser beam induces respective plasmas at the respective focal points. The respective plasmas emit respective acoustic pressure waves that control movement of the object.

These, as well as other objects, features and benefits will now become clear from a review of the following detailed description, the illustrative embodiments, and the accompanying drawings.

### BRIEF DESCRIPTION OF THE DRAWINGS

The novel features of the present disclosure will be best understood from the accompanying drawings, taken in conjunction with the accompanying description, in which similarly-referenced characters refer to similarly-referenced parts, and in which:

FIG. 1 illustrates a system and device for controlling the focus of a laser beam to induce plasmas that emit acoustic pressure waves that control the movement of an object according to an illustrative embodiment.

FIGS. 2A and 2C illustrate diffraction gratings for controlling a focus of a laser beam.

FIGS. 2B and 2D illustrate one-dimensional and two-dimensional focal patterns produced using the diffraction gratings shown in FIGS. 3A and 3C, respectively.

FIG. 3 illustrates a laser beam having multiple focal points in an axial z-direction.

FIG. 4 is a flow chart depicting a process for controlling the focus of a laser beam to induce plasmas that emit acoustic pressure waves that control the movement of an object according to an illustrative embodiment.

### DETAILED DESCRIPTION OF THE EMBODIMENTS

According to an illustrative embodiment, laser-induced plasmas emit acoustic pressure waves that control movement of an object. This is achieved by using a focus controlling component to control the focus of the laser beam to have a focal pattern with multiple focal points surrounding the object. By selecting and adjusting the focal pattern and the intensities of the laser at the focal points, the strengths and patterns of the acoustic pressure waves emitted by the induced plasmas can be controlled. These acoustic pressures waves combine to control movement of the object. In this manner, a laser beam and a focus controlling component can be used to manipulate objects or particles at the macroscopic scale.

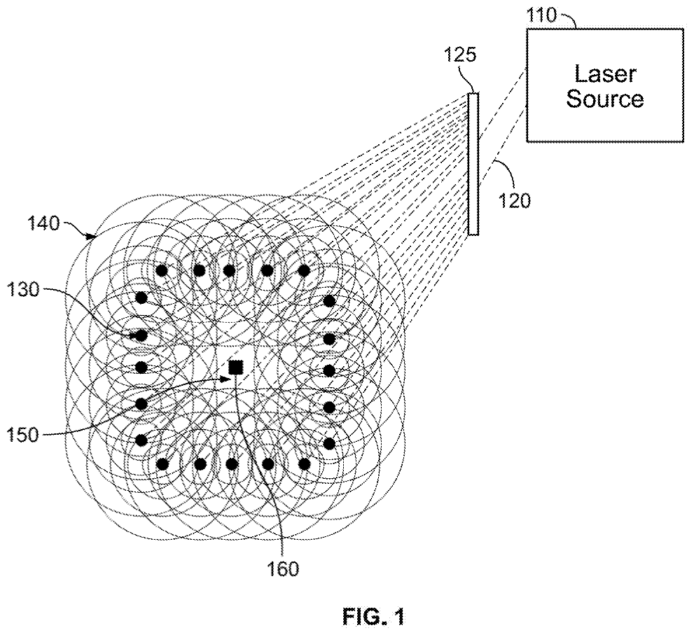

FIG. 1 illustrates a system and device for controlling the focus of a laser beam to induce plasmas that emit acoustic pressure waves to control the movement of an object. The system includes a high power laser source 110 configured to generate and output a laser beam 120. The laser source 110 may be any commercial Tera-Hertz (THz) laser source that emits lasers having a power of, for example, 10-100 joules.

The system also includes a device including a focus controlling component 125 configured to control the focus of the laser beam 120 to have multiple respective focal points 130 surrounding an object 160 in an unenclosed medium. For example, the object 160 may be located in a medium, such as air, another gaseous medium, or water. The laser source 110 and/or the focus controlling component 125 may be included in the same medium as the object 160 or in a different medium. As the object 160 is in an unenclosed medium, the laser source 110 and the focus controlling component 125 need not be close to the object but may be remote from the object, e.g., hundreds of yards away from the object.

The laser beam 120 generated and output by the laser source 110 passes through the focus controlling component 125 which controls the focus of the laser beam 120 to have multiple respective focal points 130 surrounding the object 160. As the laser beam 120 passes through the unenclosed medium in which the object 160 is contained, it induces plasmas at the focal points 130. As explained in further detail below, these plasmas emit acoustic pressure waves 140.

Though the laser beam 120 is constant, the focus controlling component 125 causes the laser beam 120 to have respective intensities at the respective focal points 130. The respective intensities may be the same or different.

In the embodiment shown in FIG. 1, the focus controlling component 125 is a phase mask. The phase mask may include depth-of-field modifying filters, such as a liquid crystal spatial light modulator (LCSLM), etch crystals, a deformable mirror, etc.

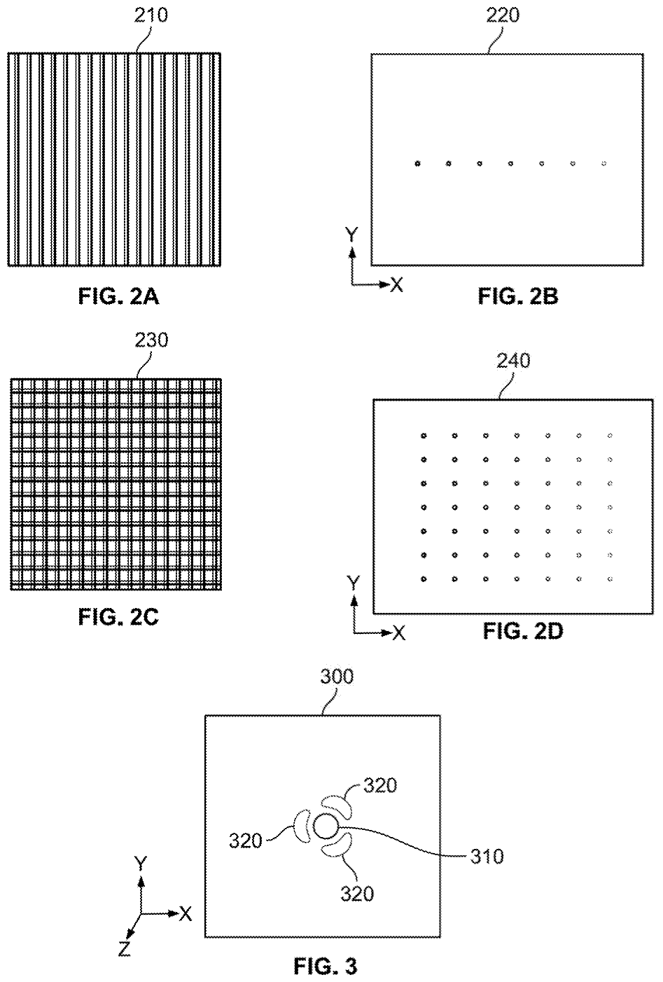

To aid in understanding how the focus controlling component 125 may be used to control the focus of a laser beam 120, examples of liquid crystal Daman diffraction gratings are shown in FIGS. 2A and 2C. The diffraction grating 210 shown in FIG. 2A has a one-dimensional diffraction pattern, while the diffraction grating 220 shown in FIG. 2C has a two-dimensional diffraction pattern. The diffraction gratings cause the laser to focus at multiple focal points in a two dimensional plane. Passing a laser beam through the diffraction grating 210 shown in FIG. 2A causes the laser to have a focal pattern 230 having multiple focal points along a single axis, e.g., an x-axis, as shown in FIG. 2B. Passing a laser beam through the diffraction grating 220 shown in FIG. 2C causes the laser to have a focal pattern 240 having focal points distributed in a two-dimensional array, e.g., focal points distributed in the x-y plane as shown in FIG. 2D.

According to an illustrative embodiment, diffraction gratings such as those shown in FIGS. 2A and 2C may be combined to form a phase mask that allows the optical depth of the laser beam's focus to be extended. A phase mask allows the focal pattern of a laser to be controlled such that focal points may be distributed not just in two dimensions but also in a third dimension, e.g., along the z-axis.

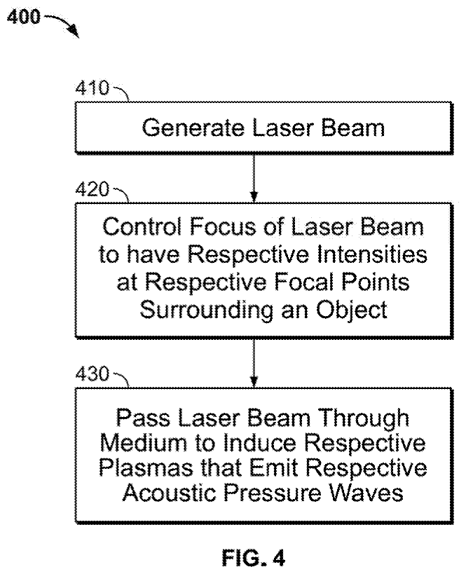

This may be understood with reference to FIG. 3 which illustrates a laser beam having a focal pattern 300 with multiple focal points in an axial z-direction. For example, the center “bright” spot 310 shown in FIG. 3 represents one focal point along the z-axis, while the surrounding “dimmer” spots 320 represent another focal point along the z-axis.

Referring again to FIG. 1, the intensities of the laser beam at the focal points, as controlled by the focus controlling component 125, determine the strengths of the acoustic pressure waves 140 induced by the plasmas at the focal points 130. The acoustic pressure waves 140 combine to cause movement of the object 160. That is, the object 160 will move to the area of minimum pressure that results from the combination of the respective acoustic pressure waves 140. The focus controlling component 125 is configured to control the focus of the laser beam such that the respective acoustic pressure waves emitted by the respective plasmas at the respective focal points 130 cause the object to move in a desired direction. Thus, by selecting and adjusting the respective intensities of the laser beam 120 at the respective focal points using the focus controlling component 125, a user may control and adjust a desired direction of movement of the object 160. Accordingly, the laser beam 120 and the focus controlling component 125 may be used efficiently to control movement of the object 160 in a desired direction within an enclosed medium.

For example, as shown in FIG. 1, the respective intensities of the laser beam 120 at the respective focal points 130 surrounding the object 160 are controlled by the focus controlling component 125 to be the same, such that the respective acoustic pressure waves 140 emitted by the respective plasmas induced at the respective focal points 130 have the same strength. In this case, the respective acoustic pressure waves 140 combine to form an acoustic trap 150 of minimum pressure around the object 160. Thus, the object 160 is caused to levitate within the acoustic trap 150.

To cause the object 160 to move in a desired direction, the focus controlling component 125 causes the respective intensities of the laser beam at the respective focal points 130 surrounding the object 160 to be different, such that the respective acoustic pressure waves 140 have different strengths. In this case, the respective acoustic pressure waves 140 would combine to push the object 160 toward an area of minimum pressure. For example, to cause the object 160 to move to the right, the focus controlling component 125 will cause the laser beam to focus with higher intensities at focal points on the left of the object and lower intensities at the focal points on the right of the object. In turn, the plasmas induced at the focal points on the left of the object 160 will emit acoustic pressure waves of greater strength than the acoustic pressures wave emitted by the plasmas induced at the focal points on the right of the object 160. The combination of these acoustic pressure waves will result in an area of minimum pressure on the right of the object. Thus, the object 160 will move to the right.

Although the system depicted in FIG. 1 demonstrates how movement of an object 160 in two dimensions can be controlled using acoustic pressure waves emitted by laser-induced plasmas, it should be appreciated that the same principles may be applied in three dimensions. That is, as indicated above with reference to FIG. 3, a focus controlling component can control the laser beam to have focal points in three dimensions. The laser-induced plasmas at these focal points will emit acoustic pressure waves that will, in turn, combine to control the movement of the object in three dimensions.

Further, although the focal points 130 shown in FIG. 1 are circular, such that the induced plasmas and the patterns of the emitted acoustic pressure waves are circular, it should be appreciated that the focus of the laser beam 120 may be controlled such that the plasmas induced at the focal points have any desired shape, and the resulting emitted acoustic pressure waves have any desired pattern. The patterns of the respective acoustic pressure waves emitted by the respective plasmas at the respective focal points 130 will vary with the respective shapes of the plasmas. These respective acoustic pressure waves will combine to control the movement of the object 160. Thus, movement of the object 160 may be further controlled by controlling the focus of the laser beam 120 to have focal points of different shapes.

As noted above, according to one embodiment, the focus controlling component 125 is a phase mask. The phase mask may have a defined combination of gratings that cause the laser beam to have a three dimensional focal pattern. Gratings which individually would produce given focal patterns can be stacked to produce a new three dimensional focal pattern. Additional gratings can be added over and over to generate a fractal effect, thus causing the laser beam 120 to have a fractal focal pattern.

Instead of or in addition to the gratings, the phase mask may include one or more spatial light modulators that cause the laser beam to have a focal pattern with multiple focal points in the z-direction.

The gratings or spatial light modulators may be replaced or switched to alter the focal pattern of the laser beam 120 and thus the direction of movement of the object 160 caused by the acoustic pressure waves 140 emitted by the plasmas at the focal points 130.

According to another embodiment, a computer-controlled phase mask, such as a computer-controlled spatial light modulator, can be utilized to change the phase mask design in real time. This allows the focal pattern of the laser beam to be altered in real time, thus altering the direction of movement of the object 160 caused by the acoustic pressure waves 140 emitted by the plasmas at the focal points 130.

An advantage of a phase mask is that the respective focal points are generated simultaneously. However, although not shown in FIG. 1, it should be appreciated that a computer-controlled beam rasterizer (not shown) may be used instead of the phase mask to control the focus of the laser beam 120. A computer-controlled rasterizer is more design friendly than a phase mask as it does not require complex computations and experiments that are needed to design a phase mask that results in the desired multi-dimensional focal pattern.

FIG. 4 is a flow chart showing steps of a process or method for controlling the focus of a laser beam to induce plasms that emit acoustic pressure waves to control movement of an object according to an illustrative embodiment. It should be appreciated that the fewer, additional, or alternative steps may also be involved in the process and/or some steps may occur in a different order.

Referring to FIG. 4, the process 400 begins at step 410 at which a laser beam is generated by any suitable high power laser source, e.g., the laser source 110 shown in FIG. 1. At step 420, a focus of the laser beam is controlled to have respective focal points surrounding an object in an unclosed medium. This step may be performed by a focus controlling component, such as the focus controlling component 125 shown in FIG. 1. At step 430, the laser beam is passed through the unenclosed medium to induce respective plasmas at the respective focal points such that respective plasmas emit respective acoustic pressure waves that control movement of the object in the medium. The respective acoustic pressure waves may cause the object to move in a desired direction and/or cause the object to levitate.

Although not shown, it should be appreciated that an additional step may be included for adjusting the focus of the laser beam as desired so as to adjust the direction of movement of the object.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A device, comprising:
a focus controlling component configured to control a focus of a laser beam to have respective focal points surrounding an object, wherein the laser beam induces respective plasmas at the respective focal points, and wherein the respective plasmas emit respective acoustic pressure waves that control movement of the object.

2. The device of claim 1, wherein the focus controlling component is configured to control the focus of the laser beam such that the laser beam has respective intensities at the respective focal points.

3. The device of claim 1, wherein the focus controlling component is configured to control the focus of the laser beam such that the respective acoustic pressure waves emitted by the respective plasmas at the respective focal points cause the object to levitate.

4. The device of claim 1, wherein the focus controlling component is configured to control the focus of the laser beam such that the respective acoustic pressure waves emitted by the respective plasmas at the respective focal points cause the object to move in a desired direction.

5. The device of claim 4, wherein the focus controlling component is further configured to adjust the focus of the laser beam to adjust the desired direction of movement of the object.

6. The device of claim 1, wherein the focus controlling component is a phase mask.

7. The device of claim 6, wherein the phase mask includes at least one spatial light modulator.

8. The device of claim 6, wherein the phase mask includes at least one diffraction grating.

9. The device of claim 6, wherein the phase mask includes multiple diffraction gratings that are configured to control the focus of the laser beam such that the respective focal points form a fractal focal pattern.

10. The device of claim 1, wherein the focus controlling component includes a computer-controlled beam rasterizer.

11. A system, comprising:
a laser source configured to generate and output a laser beam; and
a focus controlling component configured to control a focus of the laser beam to have a focal pattern including respective focal points surrounding an object in an unenclosed medium, wherein the laser beam induces respective plasmas at the respective focal points, and wherein the respective plasmas emit respective acoustic pressure waves that control movement of the object in the unenclosed medium.

12. The system of claim 11, wherein the medium is air.

13. The system of claim 11, wherein the medium is water.

14. The system of claim 11, wherein the focus controlling component is a phase mask.

15. The system of claim 14, wherein the phase mask includes at least one of a liquid crystal spatial light modulator, an etch crystal, and a deformable mirror.

16. The system of claim 11, wherein the focus controlling component includes a computer-controlled beam rasterizer.

17. A method, comprising:
generating a laser beam;
controlling a focus of the laser beam such that the laser beam has respective intensities at respective focal points surrounding an object in an unenclosed medium;
passing the laser beam through the unenclosed medium to induce respective plasmas at the respective focal points, wherein the respective plasmas emit respective acoustic pressure waves that control movement of the object in the unenclosed medium.

18. The method of claim 17, wherein the focus of the laser beam is controlled such that the respective acoustic pressure waves emitted by the respective plasmas at the respective focal points cause the object to levitate.

19. The method of claim 17, wherein the focus of the laser beam is controlled such that the respective acoustic pressure waves emitted by the respective plasmas at the respective focal points cause the object to move in a desired direction.

20. The method of claim 19, further comprising adjusting the focus of the laser beam to adjust the desired direction of movement of the object.
